(19) United States
(12) Patent Application Publication
(10) Pub. No.: US 2026/0160283 A1
(43) Pub. Date: Jun. 11, 2026

(54) CLAMPS WITH INTERCHANGEABLE MEMBERS

(71) Applicant: MARK B. BLAZEI, Ormond Beach, FL (US)

(72) Inventor: MARK B. BLAZEI, Ormond Beach, FL (US)

(21) Appl. No.: 19/414,254

(22) Filed: Dec. 9, 2025

Related U.S. Application Data
(60) Provisional application No. 63/729,478, filed on Dec. 9, 2024.

(51) Int. Cl. F16B 2/10; F16M 13/02

(52) U.S. Cl. CPC F16B 2/10; F16M 13/022

(57) ABSTRACT

A clamp apparatus configured to be removably secured to an existing baluster and to support interchangeable accessories. The apparatus includes a clamp body that engages the baluster via a sleeve or channel sized for different baluster profiles, and an accessory interface configured to releasably receive and retain a corresponding coupling on an accessory (e.g., shelf, basket, tray, planter, or tabletop). The clamp body includes a locking mechanism to generate clamping force without damaging the baluster and may include anti-rotation and anti-creep features. Interchangeable sleeves accommodate different baluster sizes and shapes. The accessory interface may include a fork-and-ledge, T-slot, dovetail, bayonet, or magnetic-mechanical coupling. The apparatus can be positioned at an arbitrary height on the baluster and supports load-bearing accessories without permanent modification of the railing.

### CROSS-REFERENCE

This U.S. non-provisional application claims the benefit of provisional application No. 63/729,478 filed Dec. 9, 2024, the subject matter of which is expressly incorporated by reference herein.

### FIELD OF THE INVENTION

The invention relates generally to an apparatus having interchangeable members. More particularly, the invention relates to a clamp and interchangeable common utilities for attachment to balusters, that combine to allow for both flexible arrangements and space-saving opportunities.

### BACKGROUND

Currently there are a number of solutions for freeing up balcony floor space and/or providing added utility to the space. One of these solutions attempts to utilize hanging baskets from railing ledge, but this solution fails to meet the needs of the market because the method is limited to baskets only. Another solution attempts to use an over railing mount, but this solution is similarly unable to meet the needs of the market because it services only one purpose, it is not interchangeable.

It would be advantageous to have an improved apparatus that can easily be affixed to or detached from balusters of standard railing systems and can provide custom mounting solutions of common utilities. Furthermore, it would also be advantageous to have an apparatus that allows the user to accessorize and customize their balcony/patio space. Still further, it would be advantageous to have an apparatus that does not alter the structural elements or causes damage to existing railings and balusters. The apparatus of the present disclosure can fulfill an unmet need by providing a space-saving customizable clamp having a plurality of interchangeable common utilities for attachment to balusters.

### BRIEF SUMMARY OF THE INVENTION

In one aspect, a clamp apparatus of the present disclosure can include a clamp configured to be removably couplable to an existing baluster and a plurality of interchangeable members.

In another aspect, the present disclosure is related to clamp apparatuses and systems configured to support interchangeable accessories on existing balusters at an arbitrarily selected height without permanent modification. In one embodiment, a clamp body can define a first aperture receiving a removable sleeve and a separate second aperture that at least partly forms an accessory interface for an interfacing member or accessory member. A locking mechanism can be actuatable to compress the sleeve against the baluster to secure the clamp member onto the baluster. A sleeve may be elastomeric with interior ribs to enhance friction, include external keys to prevent rotation within the first aperture, and be available as a set of interchangeable inner profiles (e.g., circular, square, rectangular). The accessory interface may take the form of a T-slot, dovetail slot, keyed cylindrical bayonet socket, or a magnetic-mechanical coupling, and can include detents or spring-biased pawls to resist accidental release; friction pads may be disposed between the clamp body, sleeve, and/or baluster.

In yet another aspect, the present disclosure is related to a clamp apparatus with a clamp member having a body portion includes a baluster port and a baluster channel arranged so that rotation of the body toward the baluster seats the baluster in the channel. An accessory interface at the top end can be formed as part of the body portion. In some embodiments, a one or more fork members with hooks can engage a ledge on the accessory. The geometry of the port/channel and a locking mechanism cooperate to generate clamping force. A moment arm between the accessory interface and the channel can produce a self-reinforcing torque that increases clamping pressure under load. The channel may include high-friction surfaces, and an L-shaped support may be provided as a platform. Accessories can include shelves, baskets, trays, tabletops, planters, and storage containers. Additional features can include UV-stabilized or corrosion-resistant materials, drainage features, tool-free locking, and a secondary safety retainer.

Another aspect of the present disclosure can include a method aspect includes positioning the clamp on a baluster, actuating the locking mechanism to secure the clamp, and engaging the accessory coupling with the accessory interface. Kits and systems may include a clamp, a plurality of sleeves having different inner profiles, and multiple accessories each with a complementary coupling to the accessory interface.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1A is a perspective view of an exemplary embodiment of a clamp apparatus of the present disclosure in an open configuration with additional sleeve members.

FIG. 1B is a perspective view of an exemplary embodiment of a clamp apparatus of the present disclosure in a closed configuration.

FIG. 1C is a perspective view of an exemplary embodiment of a clamp apparatus of the present disclosure with an interfacing member.

FIG. 2A is a perspective view of an exemplary embodiment of a clamp apparatus of the present disclosure in a partially open position.

FIG. 2B is a perspective view of an exemplary embodiment of a clamp apparatus of the present disclosure in a partially closed position.

FIG. 2C is a partially exploded perspective view of an exemplary embodiment of a clamp apparatus of the present disclosure.

FIG. 3A is a perspective view of an exemplary embodiment of a clamp apparatus on a baluster with an attachment accessory.

FIG. 3B is a partially exploded perspective view of an exemplary embodiment of a clamp apparatus on a baluster with an attachment accessory.

FIG. 3C is a perspective view of an exemplary embodiment of a clamp apparatus on a baluster with an attachment accessory.

FIG. 4A is a perspective view of an exemplary embodiment of a clamp apparatus of the present disclosure with a top interfacing aperture.

FIG. 4B is a perspective view of an exemplary embodiment of a clamp apparatus of the present disclosure with a recessed portion.

FIG. 4C is a perspective view of an exemplary embodiment of a clamp apparatus of the present disclosure with a front interfacing aperture.

FIG. 5A is a first perspective view of an exemplary embodiment of a clamp apparatus on a baluster.

FIG. 5B is a second perspective view of an exemplary embodiment of a clamp apparatus on a baluster.

FIG. 5C is a side view of an exemplary embodiment of a clamp apparatus.

FIG. 5D is a front view of an exemplary embodiment of a clamp apparatus.

FIG. 5E is a side view of an exemplary embodiment of a clamp apparatus on a baluster with an attachment accessory member.

FIG. 6A is a front perspective view of an exemplary embodiment of a clamp member on a baluster.

FIG. 6B is a rear perspective view of an exemplary embodiment of a clamp member on a baluster.

FIG. 6C is a perspective view of an exemplary embodiment of a clamp member being positioned on a baluster.

FIG. 6D is a perspective view of an exemplary embodiment of a clamp members positioned on a baluster.

FIG. 7A is a front perspective view of an exemplary embodiment of a clamp member on a baluster.

FIG. 7B is a rear perspective view of an exemplary embodiment of a clamp member on a baluster.

FIG. 8A is a front perspective view of two sets of exemplary embodiments of clamp members with attachments coupled to a baluster.

FIG. 8B is a front perspective view of two sets of exemplary embodiments of clamp members of the present disclosure coupled to a baluster.

FIG. 9A is a perspective view of an exemplary embodiment of a clamp apparatus of the present disclosure with a press locking feature in an open position.

FIG. 9B is a perspective view of an exemplary embodiment of a clamp apparatus of the present disclosure with a press locking feature in a closed position.

FIG. 9C is a top perspective view of an exemplary embodiment of a clamp apparatus of the present disclosure with a press locking feature.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in numerous ways, as the subject matter is not limited to any particular manner of implementation. Examples of specific implementations and applications are provided primarily for illustrative purposes.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s), or step(s), to the objective(s), spirit, or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

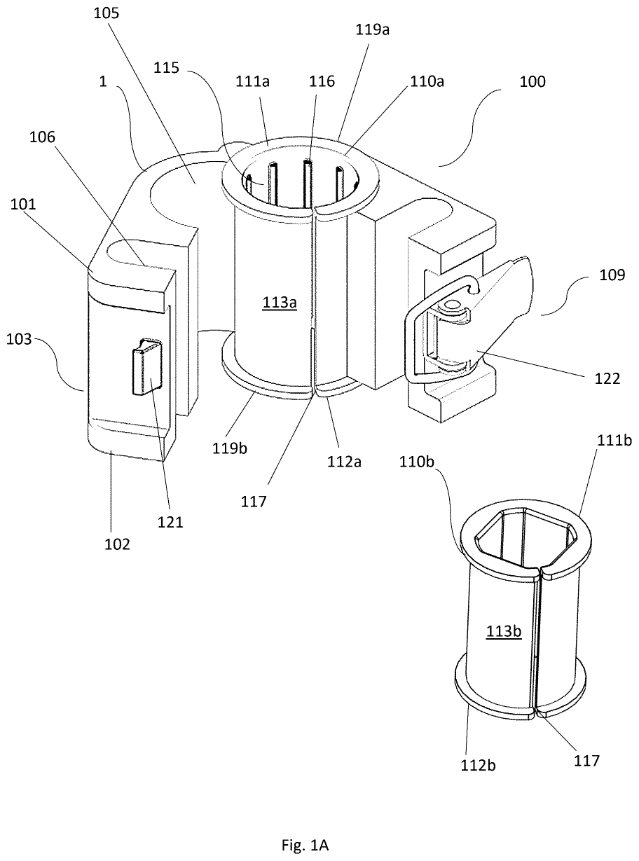

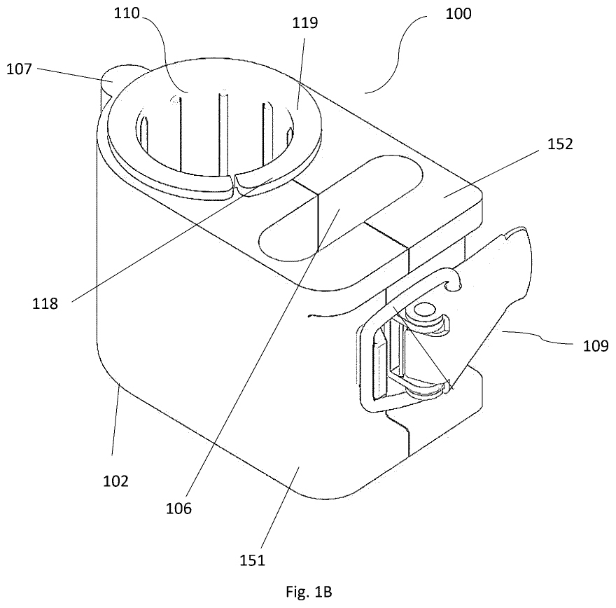

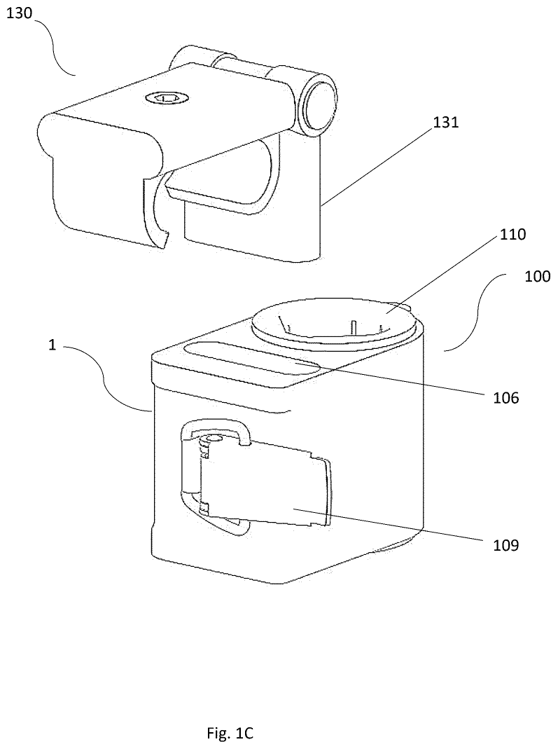

Referring now to FIGS. 1-9 that provides exemplary embodiments of customizable clamp apparatuses according to the present disclosure. As shown in FIGS. 1A-C, an exemplary embodiment of clamp apparatus of the present disclosure can comprise a clamp member 1 configured to be removably couplable to existing balusters/railings. The apparatus may comprise a body portion 10 having a top end 101, a bottom end 102, and a middle portion 103. A distance from the top end 101 to the bottom end 102 defining a height of the clamp member 1. The clamp 1 can include a first clamp portion 151 and a second clamp portion 152 that are hingedly connected.

The clamp member 1 can further include a first aperture 105 that can extend the length of the body 103. The aperture 105 can generally be round in configuration, but other suitable configurations could be used. The clamp member 1 can further include a second aperture 106 formed through the length of the body adjacent to the first aperture 105 as shown in FIGS. 1A-B. The clamp member can include two portions that are hingedly connected at a hinge 107 that can allow the two portions to be opened about the hinge. A locking mechanism 109 that can be used to maintain the two portions of the clamp 1 in a closed position. In some exemplary embodiments, the locking mechanism 109 can be a hook 121 and latch 122 configuration as shown in FIG. 1A.

The apparatus 100 can further include a sleeve member 110 that can have a first end 111 to the second end 112 with a body portion 113 formed with an exterior surface 114 and an interior surface with an aperture 115 formed. The aperture 115 can have any desired configuration to approximate the exterior dimensions of a baluster. The sleeve member 110 can be housed within the first aperture 105 of the clamp member 100. In some exemplary embodiments, the apparatus can include a first sleeve member 110a having a round aperture and a second sleeve member 110b having a generally rectangular aperture. The sleeve members 110 can be configured to be inserted within an interior volume of the clamp for assisting the clamp to be couplable to various types and sizes of balusters. The aperture can have a raised rib or interfacing member 116 that can extend generally perpendicular from the interior surface. The interfacing member 116 can provide better grip to a baluster or post. The interfacing member 116 can be comprised of a material that has a high coefficient of friction. Similarly, the interfacing member 116 can be comprised of a material that can compress when pressure from the clamp member 1 is applied to provide even more tension and friction against the baluster.

The sleeve member(s) can have channel 117 formed from the first end to the second end that can allow the sleeve members to be easily removably coupled or positioned on to a baluster before attaching the clamp member 1 around the exterior surface 113 of the sleeve member. The sleeve member 110 can further include a rim 119 that can be formed on one or both of the first end 111 and second end 112. The rim can overlie a portion of the first end 101 or second end 102 or both of the clamp member 1 as shown in FIG. 1B.

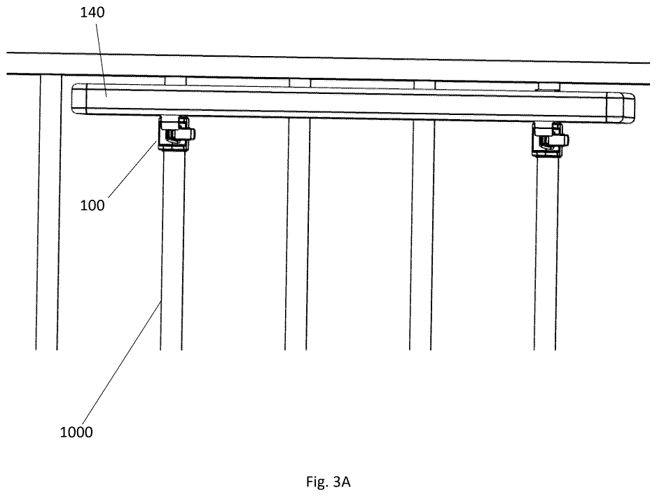

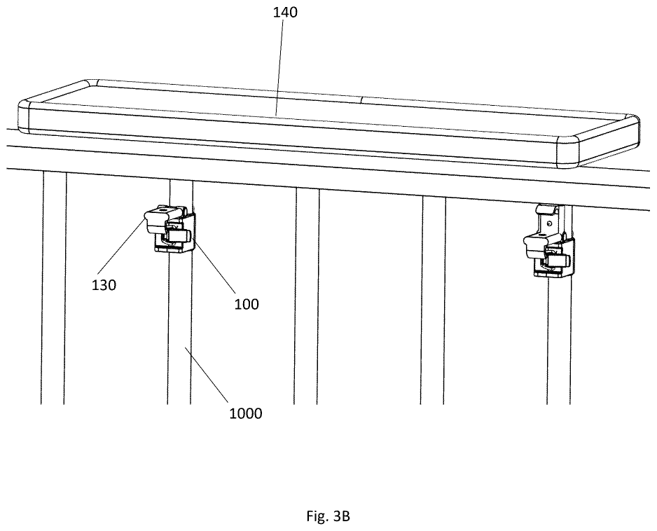

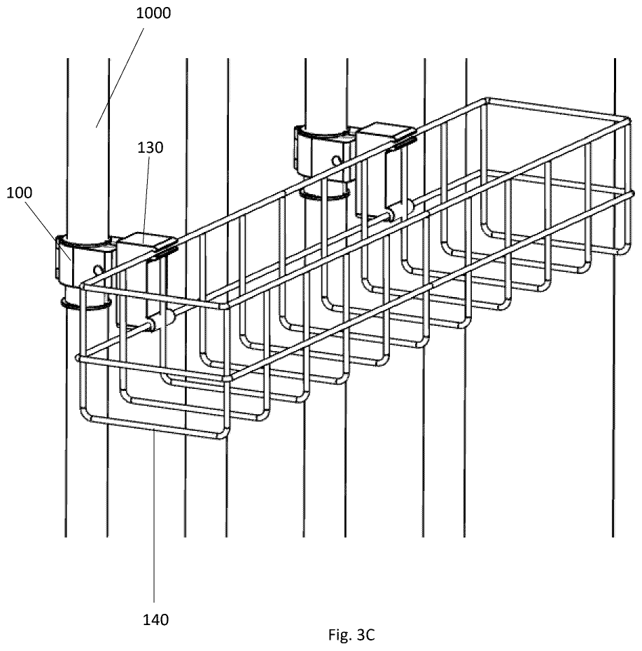

The apparatus may further comprise a plurality of interchangeable accessory members 130. The apparatus can generally have an anchoring element to receive and secure an end of at least one interchangeable members 130. The clamp member 1 and the anchoring element generally located opposite each other on a dual-purpose clamp housing. The interchangeable member 130 can have an interfacing portion 131 that can have the same configuration and correspond to the second aperture 106. The interchangeable member 130 can be configured to couple to or be integrated with an accessory portion 140 including but not limited to shelf, basket, or other type of accessory desired by a user. FIGS. 3A-C illustrate various clamp apparatuses 1 of the disclosure utilized on corresponding balusters 100 with interchangeable accessory members 130.

In some instances, the anchoring element is an aperture though the dual-purpose clamp housing, and the interchangeable member comprises a slot configured to be inserted and secured within the aperture. The interchangeable member may have at least one, or at least two, or a plurality of slots, each slot configured to be inserted and secured within one aperture of one dual-purpose clamp housing.

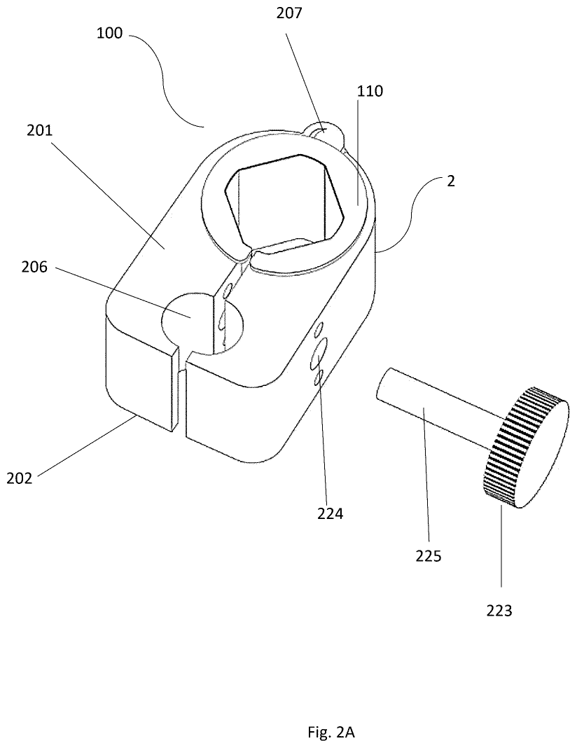

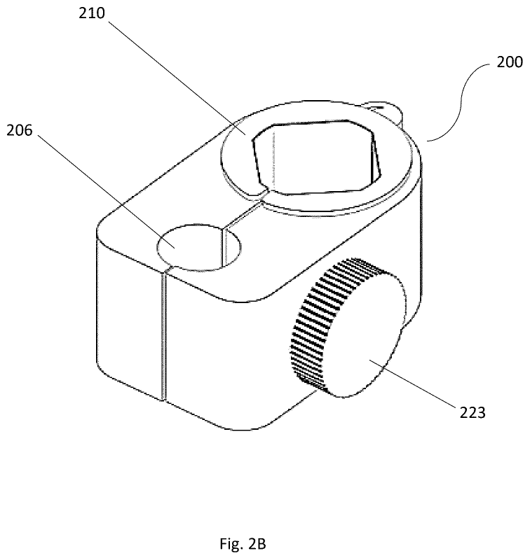

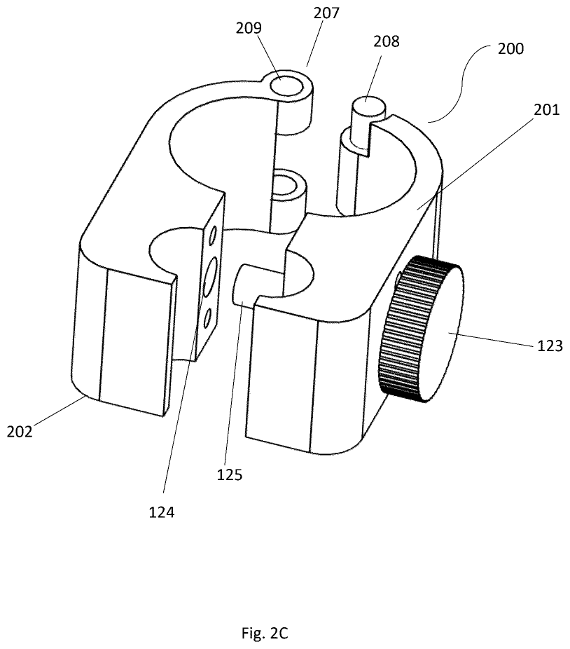

The apparatus may comprise multiple types of clamping/locking mechanisms, including but not limited to snap-on clamp, half-pipe clamp, T-slot clamp, hole clamp, slot clamp. The apparatus may further comprise an added cushion lining onto an interior wall of the clamp. The clamp may comprise a reversible locking mechanism and an adjustable mechanism. The locking mechanism 209 may comprise pins or a latch lock and the adjustable mechanism may comprise a rotating or a twist knob dial. FIGS. 2A-C illustrate a similar clamp apparatus 200 with a different coupling mechanism 209. The coupling mechanism can include a fastener 223 with a knob dial. The clamp member can have an aperture 224 that extends between the two portions. The fastener can have a threaded portion 225 that can interface with threads within the aperture to couple the two portions together around a baluster and/or the sleeve member 110. Additionally, the second aperture 206 can have a different configuration. The hinge portion 207 can include a hinge pin and corresponding apertures 208.

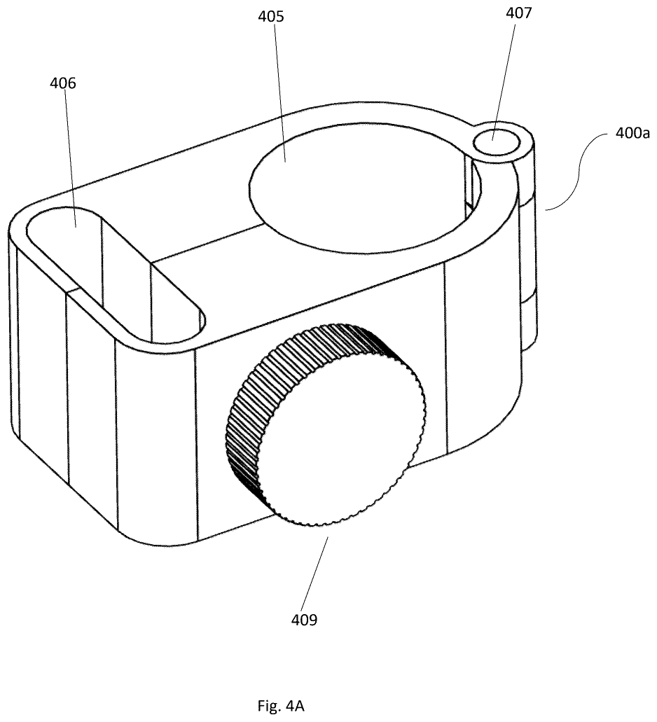

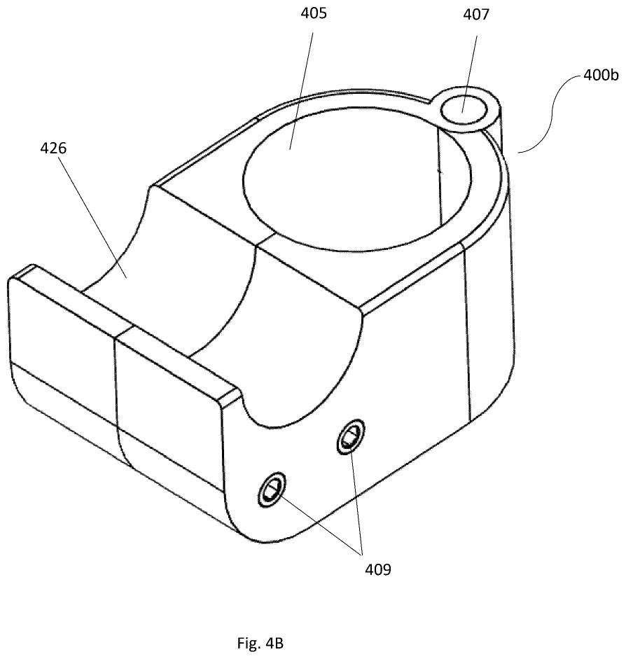

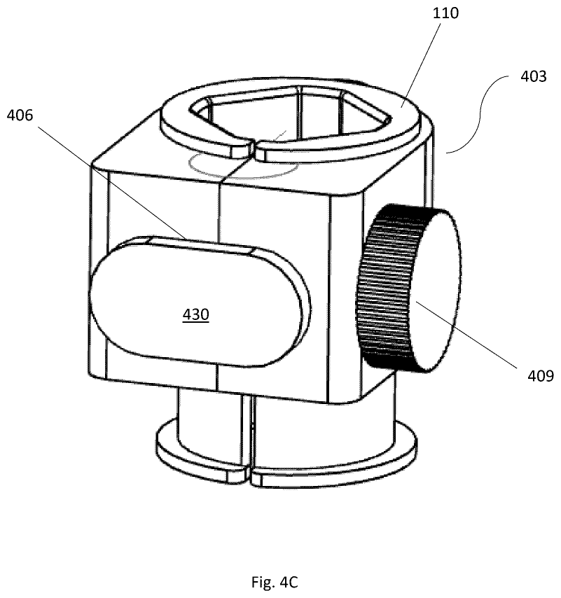

FIGS. 4A-C are illustrations of various clamp apparatus configurations. FIG. 4A is a clamp member 400a illustrating the first aperture 405 and second aperture 406 having a different configuration than the first aperture. The locking mechanism 409 can be a fastener similar to the clamp member shown in FIGS. 2A-C. The clamp member shown in FIG. 4B provides another clamp configuration having a recessed portion 426 that can be curved to form a hook portion on a side of the clamp member 400b. Additionally, in some exemplary embodiments, the locking mechanism can include more than one fasteners that be used to couple first portion of the clamp member to the second portion of the clamp member. FIG. 4C provides an exemplary embodiment of a clamp member with a second aperture 406 on a front surface of the clamp member. An interchangeable member 430 can be removably coupled into the aperture to provide for a way to mount additional accessory members. The sleeve member 110 can be used with the various clamp member embodiments. The clamp members can compress the sleeve member around a pole or baluster.

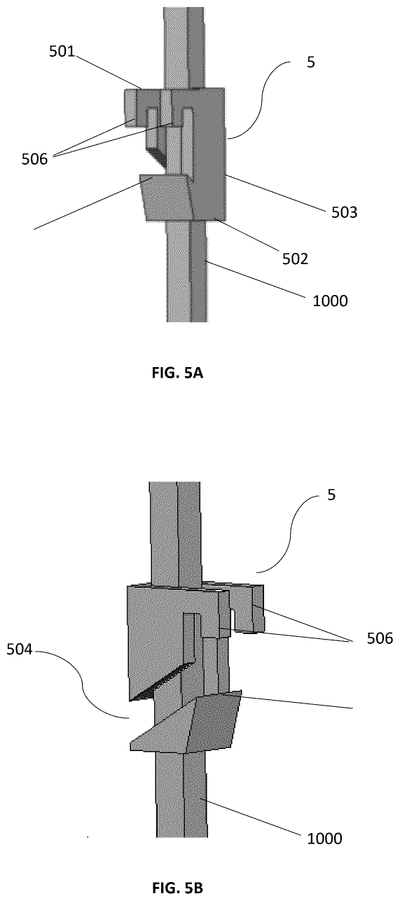

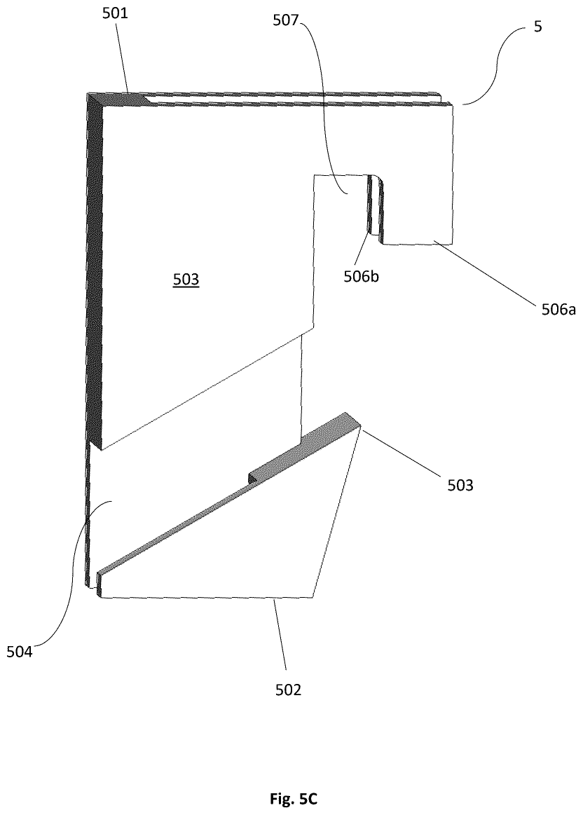

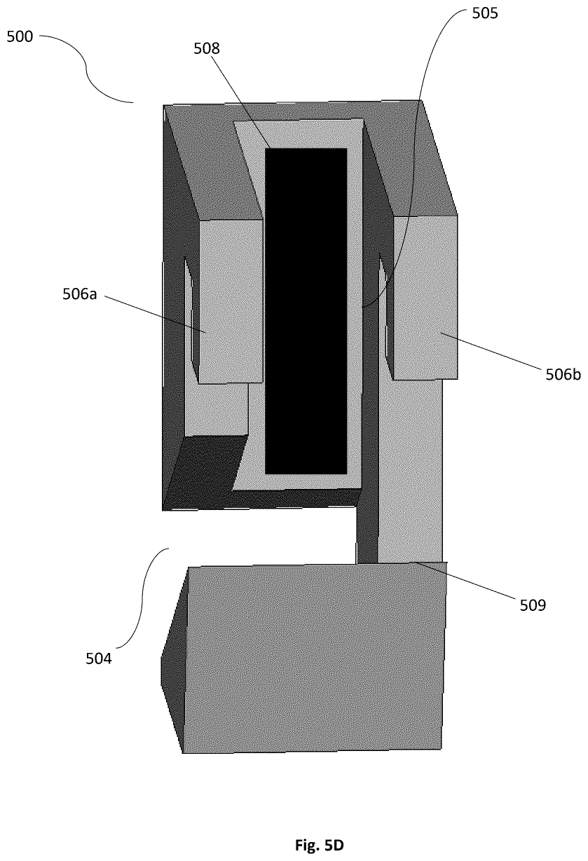

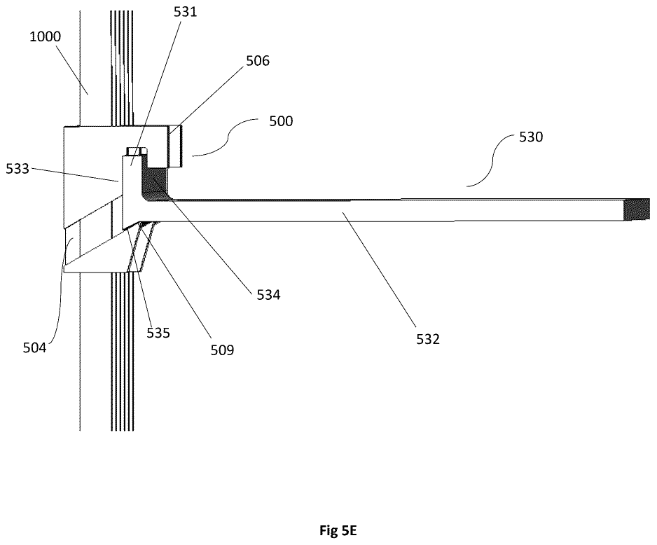

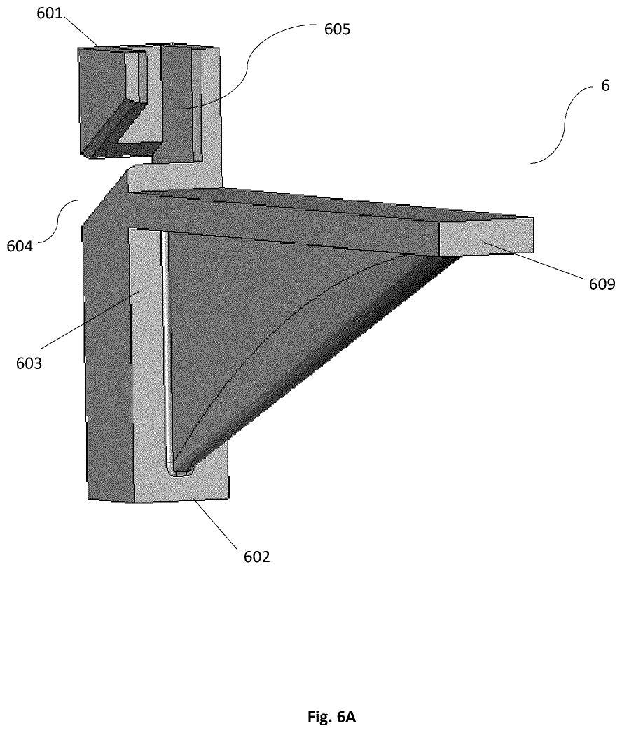

As shown in FIGS. 5A-E, an exemplary embodiment of a clamp apparatus can have a distance from the top end 501 to the bottom end 502 defining a height of the clamp member 5 configured to be removably couplable to existing balusters/railings 1000. The apparatus 500 may comprise a top end 501, a bottom end 502, and a middle portion 503. A distance from the top end 501 to the bottom end 502 can define a height of the clamp member 5. The middle or body portion 503 can generally be any suitable shape. In some exemplary embodiments, the body portion 503 can generally be rectangular in shape having four sides. The channel 505 can generally be formed along at least one of the sides and the port being formed on an adjacent side to the channel. The clamp member 5 can generally have a first cavity or channel 504 (baluster port) located proximate to the bottom end 502 of the member. In some exemplary embodiments, the baluster port 504 can be configured to receive a portion of a pole, such as an existing baluster, and to allow for the portion of the pole to be inserted through the baluster port 504 and into the clamp member 5 as a first step of coupling the clamp member 5 to the pole 1000. The clamp member 5 can further have a second cavity 505 (baluster channel) starting from the bottom end 502 and extending upwardly up to the top end 501, through the middle portion 503. The baluster port 504 can interface with the baluster channel 505. The second cavity/channel 505 can be configured to allow for the clamp member 5 to be removably coupled to an existing baluster 1000 and secured/locked at any desired height of the existing baluster, wherein a second step of coupling the clamp member 5 to the pole is to rotate the body portion 503 towards the pole, in a way that the portion of the pole will be inserted within the baluster channel 505 as shown in FIGS. 5A-B. The body portion 503 can include a first inner sidewall and a second inner sidewall within the channel portion 505, wherein the first inner sidewall interfaces with a first side of a baluster and the second inner sidewall interfaces with a second side of a baluster. The configuration of the top end, bottom end, weight distribution, and baluster channel creates leverage and friction through gravity against the baluster to maintain the clamp member on the baluster. A friction member can be formed or coupled to the one or more first and/or second inner sidewalls.

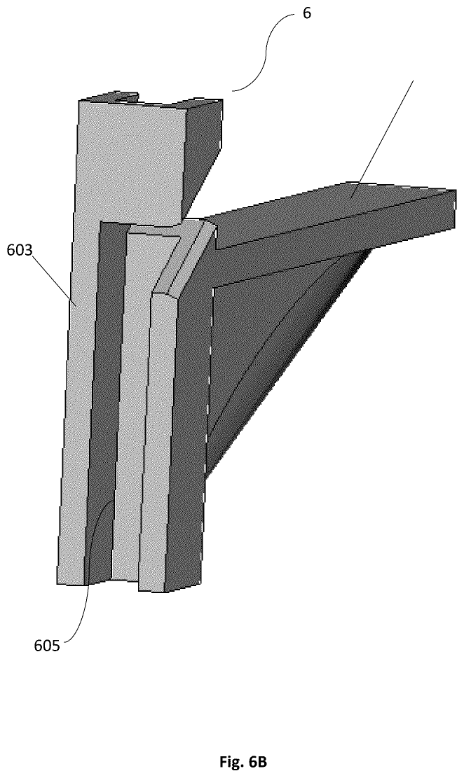

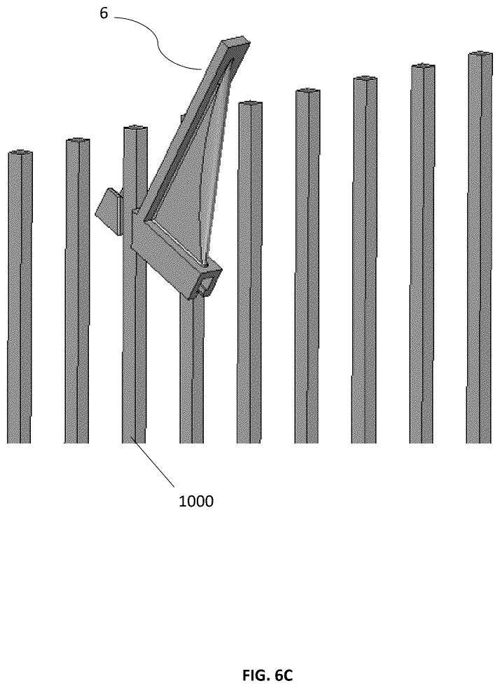

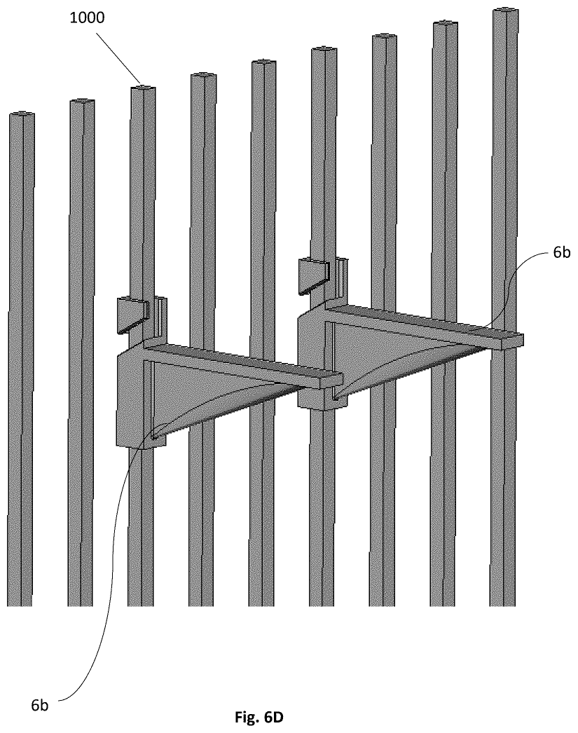

As shown in FIGS. 5C-D, a top end 501 may comprise a fork-like structure(s) 506, to facilitate attachment of the removable member 2. The fork-like structure(s) 506 generally protruding outwardly and substantially perpendicular in relation to the body portion 503. An end of the fork-like structure 506 generally curved, forming a hook 507, capable of holding and securing an end of the removable member 540. Additionally, the baluster port 504 can form an edge 509 that can extend past the main body portion 503 but does not extend as far from the body portion as the fork structure(s) 506 as shown in FIG. 5C. In some exemplary embodiments, a pad or friction member 508 can be coupled to or incorporated as part of the clamp member within one or more walls forming the baluster channel 505. To resist vertical creep under load, the clamp-to-baluster interface may include serrated or high-friction pads 508 arranged such that the resultant normal force vector biases the clamp against downward motion. In the port/channel embodiments illustrated in FIGS. 5-6, a moment arm between the accessory interface and the baluster channel produces a self-reinforcing torque under gravity to increase clamping pressure as accessory load increases.

The hook can interface with a ledge 541 of an associated accessory member 540 as shown in FIG. 5E. The ledge 531 can have a first side 533 and a second side 534 wherein the first side contacts a portion of the body 503 of the clamp member 5 and the second side contacts one or more of the fork-like structures 506. A shelf portion can extend generally perpendicular from the ledge 531. The accessory member 530 can also have an angular portion 535 that extends below the ledge and corresponds to the angle of the port 504 and interface with the edge 509 of the body portion. At least one clamp member 5 may be coupled to a baluster and at least one interchangeable accessory member 530 may be coupled to the top end 101 of the clamp member. The accessory member 530 can be positioned within the hook area 507 and then when rotated in can rest onto the edge 509. The weight of the accessory member 530 can increase clamping pressure between the channel walls and the baluster. The top end 501 is capable of receiving and securing at least one removable accessory member 530. The removable member 2 may be selected from the group including, but not limited to: tabletops, corner tabletops, baskets, trays, shelves, storage containers and other utility furnishing accessories, and combinations thereof.

In some alternative embodiments, the first cavity 604 (baluster port) can be located at the top end of the body member 10 as shown in FIGS. 6A-D. The clamp member 5 can have a first end 601 and a second end 602 with a body portion formed between the two ends. In some exemplary embodiments, the body portion 503 can generally be rectangular in shape having four sides. The channel 505 can generally be formed along at least one of the sides and the port being formed on an adjacent side to the channel. A similar clamp member 6 includes an extension portion 609 that extends generally perpendicular from the body 603 of the clamp member 6. In some embodiments, the body portion 10 may further comprise an L-shaped member 108 that can be integral to the body portion 10 or removably coupled to the body portion 10. The L-shaped member 108 having a flat surface 109 capable of receiving the removable member 2, such as a flat tray. The body portion 603 can include a first inner sidewall and a second inner sidewall within the channel portion 605, wherein the first inner sidewall interfaces with a first side of a baluster and the second inner sidewall interfaces with a second side of a baluster. The configuration of the top end, bottom end, weight distribution, and baluster channel creates leverage and friction through gravity against the baluster to maintain the clamp member on the baluster. A friction member can be formed or coupled to the one or more first and/or second inner sidewalls.

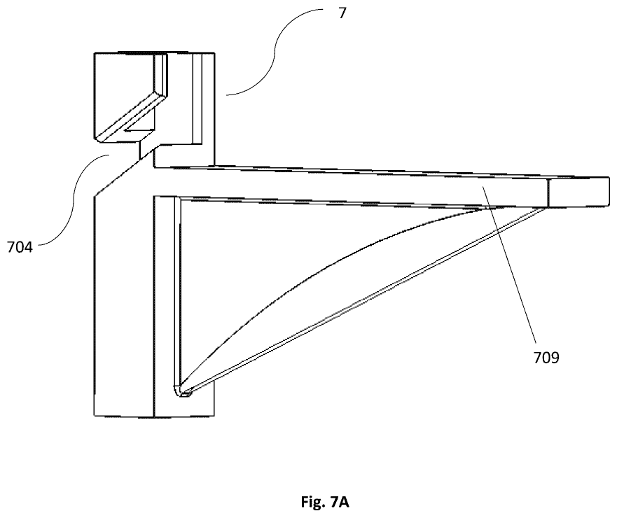

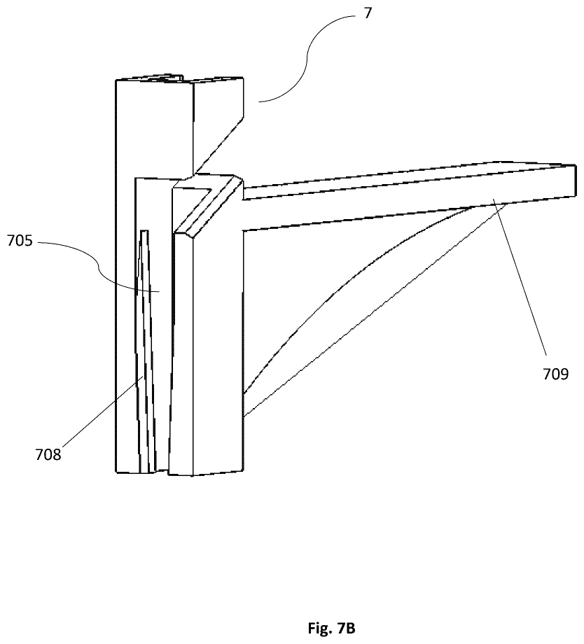

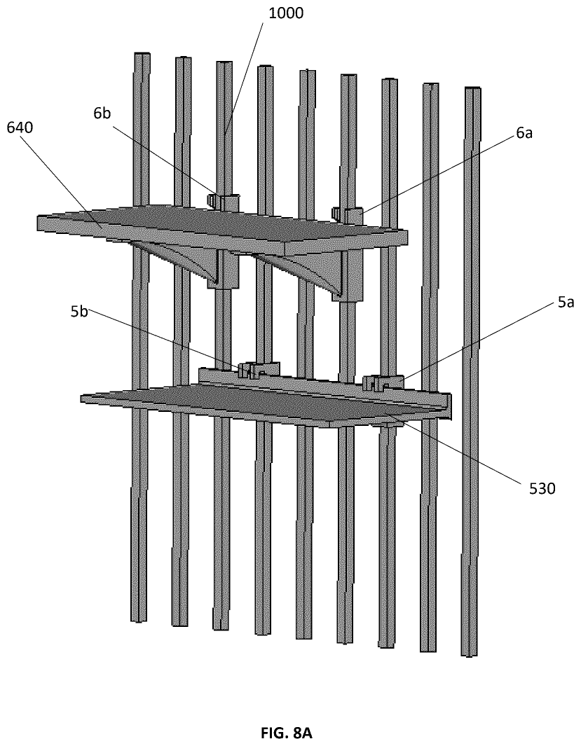

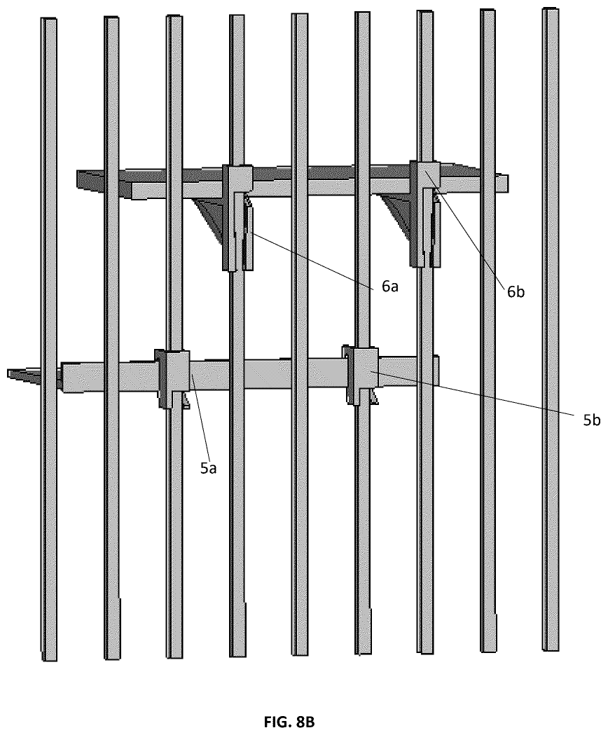

FIGS. 7A-B are illustrations of a similar clamp apparatus wherein the baluster channel includes additional gripping members 706 positioned along the channel 705 to provide additional friction and pressure against the baluster. FIGS. 8A-B illustrate various clamp apparatuses of the present disclosure coupled to balusters with accessory members. The different clamp members can be used with different accessory components corresponding to the relative type of clamp and locking portion of the clamps.

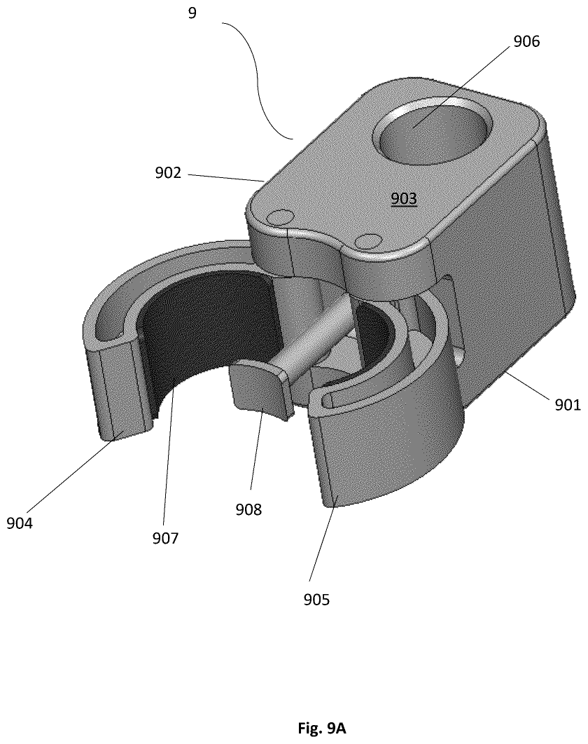

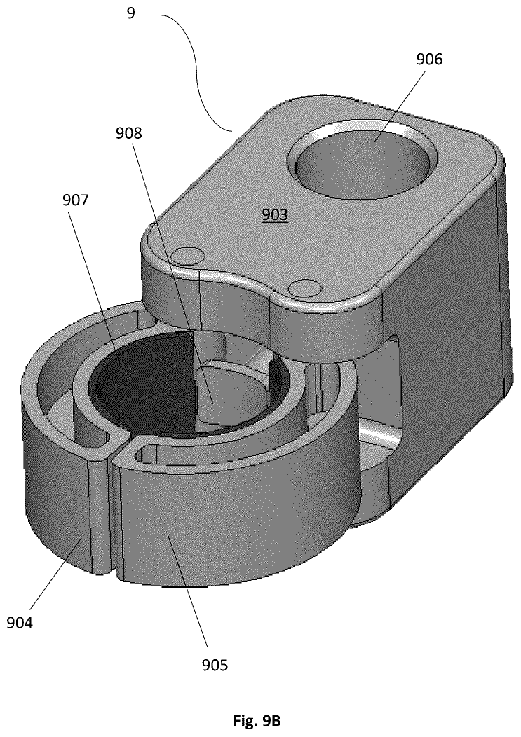

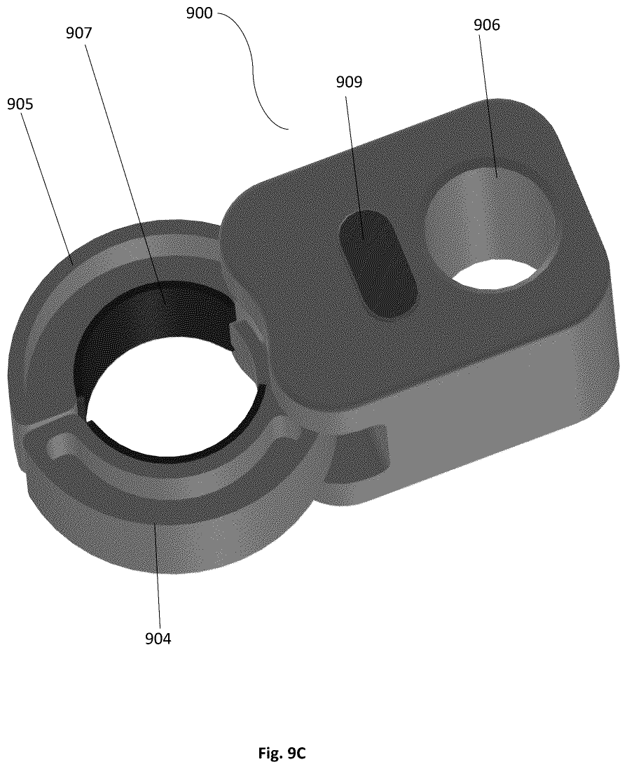

FIG. 9A-B illustrate an exemplary embodiment of a clamp member 9 of the present disclosure that can be pushed to lock clamp member. The clamp member 9 can include a first end 901 and a second end 902 with a body portion 903 formed between the two end. A first clamp portion 904 and a second clamp portion 905 can be pivotably connected to the body portion 903 of the clamp member 9. A plunger portion 908 can be extended out when the clamp member is in an open position. Upon being depressed, the plunger portion 908 can be in communication with the first and second clamp portions and move the clamp portions into a closed position around a pole or baluster. A clamp friction pad or member 907 can be formed or coupled to the interior surface of one or more of the clamp portions to provide better grip and friction against the baluster to maintain the clamp member 9 on the baluster. The body portion 903 can further include an aperture 906 configured to interface with an interfacing member or an accessory member. The clamp member 9 can further include a locking mechanism 909 that can include a button configured to release the clamp portions when depressed to remove the clamp member 9.

The apparatus is made of lightweight and durable materials, such as high-density and anti-static plastic, for easy transport and secure anchor of the interchangeable members. The accessory interface may include, alone or in combination: (i) a transverse T-slot configured to engage a complementary T-stud on an accessory; (ii) a dovetail slot with a flared entry; (iii) a keyed cylindrical socket receiving a bayonet post with quarter-turn lock; (iv) opposed fork members] with hooks engaging a ledge or rail of the accessory; and/or (v) a magnetic coupling supplemented by a mechanical retainer to meet drop-load safety. The interface may include detents or spring-biased pawls to resist accidental release, and visual indicators confirming full engagement.

In some exemplary embodiments, the clamp members and inner sleeve suitable materials include thermoplastic elastomers (TPE), thermoplastic polyurethane (TPU), silicone rubber, ethylene propylene diene monomer (EPDM), and nitrile rubber. In other alternative embodiments, clamp body may be formed from glass-filled nylon, acetal (POM), aluminum alloy (e.g., 6061-T6), stainless steel, or zinc die cast or other suitable materials.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A clamp apparatus for supporting an accessory on a baluster, comprising:
a clamp member defining a first aperture sized to receive a sleeve member and a second aperture separate from the first aperture;
a sleeve member removably received in the first aperture, the sleeve defining an interior passage configured to receive at least a portion of a baluster having one of a plurality of cross-sectional shapes; and
an accessory interface defined at least in part by the second aperture and configured to releasably engage a complementary coupling on the accessory,
wherein the clamp member comprises a locking mechanism actuatable to compress the sleeve against the baluster to secure the clamp apparatus at a selected position along the baluster.

2. The clamp apparatus of claim 1, wherein the sleeve member comprises an elastomeric material and at least one interior rib configured to increase friction against the baluster when the locking mechanism is actuated.

3. The clamp apparatus of claim 1, wherein the sleeve comprises external keys configured to mate with complementary grooves of the first aperture to prevent rotation of the sleeve relative to the clamp body.

4. The clamp apparatus of claim 1, wherein the locking mechanism comprises at least one of: a threaded fastener with a knob, an over-center cam latch, a hook-and-latch buckle, or a ratcheting strap.

5. The clamp apparatus of claim 1, wherein the accessory interface comprises a T-slot configured to receive a complementary T-stud of the accessory.

6. The clamp apparatus of claim 1, wherein the accessory interface comprises a dovetail slot with a flared entry.

7. The clamp apparatus of claim 1, wherein the accessory interface comprises a keyed cylindrical socket configured to receive a bayonet post on the accessory.

8. The clamp apparatus of claim 1, further comprising a detent or spring-biased pawl configured to resist accidental release of the accessory from the accessory interface.

9. The clamp apparatus of claim 1, further comprising at least one friction pad disposed between the clamp body and the sleeve or between the sleeve and the baluster.

10. The clamp apparatus of claim 1, wherein the sleeve set comprises at least a circular-profile sleeve, a square-profile sleeve, and a rectangular-profile sleeve.

11. A customizable clamp apparatus, comprising:
a clamp member having a body portion, a top end, a bottom end, and a middle portion,
a first cavity (baluster port);
a second cavity (baluster channel) starting from the first cavity and extending through the middle portion;
wherein the first cavity is configured to receive a portion of a pole, such as an existing baluster, and to allow for the portion of the pole to be inserted within the clamp member as a first step of coupling the clamp member to the pole, and the second cavity is configured to allow for the clamp member to be removably coupled to an existing baluster and secured at any desired height of the existing baluster, wherein a second step of coupling the clamp member to the pole is to rotate the body portion towards the pole, in a way that the portion of the pole will be inserted within the second cavity.

12. The customizable clamp apparatus of claim 11, wherein the top end is capable of receiving and securing at least one removable member.

13. The customizable clamp apparatus of claim 12, wherein the removable member may be selected from the group consisting of: tabletops, corner tabletops, baskets, trays, shelves, storage containers and other utility furnishing accessories, and combinations thereof.

14. The customizable clamp apparatus of claim 12, wherein the top end comprises a fork-like structure to facilitate attachment of the removable member.

15. The customizable clamp apparatus of claim 14, wherein the fork-like structure is protruding outwardly and substantially perpendicular in relation to the body portion.

16. The customizable clamp apparatus of claim 15, wherein an end of the fork-like structure is curved, forming a hook, capable of holding and securing an end of the removable member.

17. The customizable clamp apparatus of claim 11, wherein the first cavity is located at the bottom end and the second cavity extends upwardly through the middle portion.

18. The customizable clamp apparatus of claim 11, wherein the first cavity is located at the top end and the second cavity extends downwardly through the middle portion.

19. The customizable clamp apparatus of claim 11, wherein the body portion further comprises an L-shaped member, the L-shaped member having a flat surface capable of receiving the removable member, such as a tray.

20. The customizable clamp apparatus of claim 19, wherein the L-shaped member is integral to the body portion or removably coupled to the body portion.
